(19) United States
(12) Patent Application Publication
(10) Pub. No.: US 2026/0107098 A1
(43) Pub. Date: Apr. 16, 2026

(54) COMBINED ANTENNA AND IN-THE-CANAL HEARING AID

(71) Applicant: Yeasound (Xiamen) Hearing Technology Co., Ltd, Xiamen (CN)

(72) Inventors: Jianhang Shen, Xiamen (CN); Jiaxiang Liao, Xiamen (CN); Kaiwen Huang, Xiamen (CN); Huahu Wang, Xiamen (CN)

(21) Appl. No.: 19/031,225

(22) Filed: Jan. 17, 2025

(30) Foreign Application Priority Data
Oct. 15, 2024 (CN) 202422488426.8

(51) Int. Cl. H04R 25/00; H01Q 1/27

(52) U.S. Cl. CPC H04R 25/609; H01Q 1/273; H04R 25/554; H04R 2225/023; H04R 2225/51

(57) ABSTRACT

A combined antenna and an in-the-canal hearing aid are provided. The combined antenna includes an antenna body and an antenna motherboard, where a signal connection is established between at least one end of the antenna body and the antenna motherboard; the antenna body includes a first antenna and a second antenna; a signal connection is established between the first antenna and the antenna motherboard; and a signal connection is established between the second antenna and the first antenna. The first antenna of the combined antenna is disposed inside a hearing aid body of the in-the-canal hearing aid, and the second antenna of the combined antenna is disposed outside the hearing aid body of the in-the-canal hearing aid, which can improve communication performance of the in-the-canal hearing aid through the combined antenna.

### CROSS REFERENCE TO RELATED APPLICATIONS

The present application claims the benefit of Chinese Patent Application No. 2024224884268 filed on Oct. 15, 2024, the contents of which are incorporated herein by reference in their entirety.

### TECHNICAL FIELD

The present disclosure relates to the technical field of in-the-canal hearing aids, and specifically, to a combined antenna and an in-the-canal hearing aid.

### BACKGROUND

With the development of science and technology, hearing aids have become widespread, and existing hearing aids not only have a hearing aiding function, but can also replace wireless earphones. A Radio Frequency (RF) function on the hearing aid allows the hearing aid to cooperate with a mobile phone to switch different modes in different scenarios, such as noisy, music, outdoor, and indoor scenarios. Gains for external noise and useful sound vary in different modes, allowing people to pay more attention to what they want to do. The RF function can also connect two hearing aids to achieve directional perception. The hearing aid is essentially equipped with an antenna to achieve an RF communication capability. In addition, in order to improve wearing concealment and aesthetic appeal for the hearing aid, more hearing aid manufacturers are paying attention to development of an in-the-canal hearing aid.

However, due to a small size of a body of the in-the-canal hearing aid, internal space of the hearing aid is very small. In the prior art, an antenna used to achieve a communication function is disposed inside the hearing aid. As a result, the designed antenna has poor performance, resulting in a poor effect and a poor signal.

### SUMMARY

In order to solve the above technical problems, the present disclosure provides a combined antenna and an in-the-canal hearing aid, which are configured to improve communication performance of the antenna and a hearing aiding effect of the in-the-canal hearing aid while meeting a design requirement of a small volume of the in-the-canal hearing aid.

In order to achieve the above objective, according to a first aspect, the present disclosure provides a combined antenna, including an antenna body and an antenna motherboard, where
a signal connection is established between at least one end of the antenna body and the antenna motherboard;
the antenna body includes a first antenna and a second antenna;
a signal connection is established between the first antenna and the antenna motherboard; and
a signal connection is established between the second antenna and the first antenna.

The present disclosure divides the antenna body into the first antenna and the second antenna. The signal connection is established between the first antenna and the antenna motherboard, which facilitates the first antenna in receiving a signal from the antenna motherboard. In addition, the signal connection is established between the first antenna signal and the second antenna to implement signal transmission between the first antenna and the second antenna. Through the signal connection among the first antenna, the antenna motherboard, and the second antenna, communication performance of an antenna of an in-the-canal hearing aid is achieved.

As a preferred example, the antenna body is any one of an inverted-F antenna, a loop antenna, and a folded monopole antenna.

The present disclosure sets a type of the antenna body to the any one of the inverted-F antenna, the loop antenna, or the folded monopole antenna to adapt to different internal space settings of a plurality of types of in-the-canal hearing aids, reasonably reduce space occupied by the antenna, and improve practical performance of the antenna.

As a preferred example, the signal connection between the antenna body and the antenna motherboard includes a direct connection and an indirect connection.

The present disclosure sets a connection method between the antenna body and the antenna motherboard to the direct connection and the indirect connection, which can improve flexibility of disposing the antenna of the in-the-canal hearing aid, thereby expanding adaptability of an application scenario of the antenna and stabilizing performance of the antenna.

As a preferred example, the indirect connection is a coupling connection between the antenna body and the antenna motherboard through a high-frequency signal.

In the present disclosure, the coupling connection is established between the antenna motherboard and the antenna body through the high-frequency signal, which expands flexibility of setting an antenna communication scheme and can improve the communication performance of the antenna by achieving the signal connection through high-frequency signal coupling.

As a preferred example, the antenna body is equipped with at least one signal connection node for achieving a signal connection to a chip on the antenna motherboard when the antenna body is directly connected to the antenna motherboard.

Based on different types of antenna bodies, the present disclosure disposes the at least one signal connection node on the antenna body to achieve the signal connection between the antenna body and the chip on the antenna motherboard through the signal connection node, thereby ensuring communication stability of the antenna and improving the performance of the antenna.

As a preferred example, the signal connection between the first antenna and the second antenna includes a direct connection and an indirect connection.

The present disclosure can further improve the flexibility of disposing the antenna in the in-the-canal hearing aid by providing diverse connection methods between the first antenna and the second antenna in the antenna body. In addition, a characteristic that the second antenna may be directly or indirectly connected to the first antenna is utilized to make the combined antenna adapt to different types of communication needs and ensure the communication performance of the antenna.

According to a second aspect, the present disclosure provides an in-the-canal hearing aid, including an earplug, a hearing aid body, and the combined antenna described in the first aspect, where
the earplug is fixedly connected to the hearing aid body; the hearing aid body is internally equipped with a main control board, and an antenna motherboard of the combined antenna is integrated on the main control board; a first antenna of the combined antenna is disposed inside the hearing aid body; and a second antenna of the combined antenna is disposed outside the hearing aid body, and a signal connection is established between the second antenna and the first antenna.

The antenna body of the in-the-canal hearing aid provided in the present disclosure includes the second antenna and the first antenna. The earplug is used to enhance stability of fixing the hearing aid in an ear canal. The first antenna is disposed inside a shell of the hearing aid and implements a signal connection to the antenna motherboard on the main control board disposed inside the hearing aid body to achieve internal deployment of an antenna of the in-the-canal hearing aid. The signal connection is established between the second antenna and the first antenna. Therefore, while communication between the antennas is maintained, performance of the antenna can be implemented and enhanced through the second antenna, and a design requirement of a small-volume body of the in-the-canal hearing aid is met.

As a preferred example, a string for removing and wearing the hearing aid is further included, where at least one end of the string is fixedly connected to the hearing aid body.

As a preferred example, head and tail ends of the string are both fixedly connected to the hearing aid body, and a protrusion capable of extending outside the hearing aid body is disposed between the head and tail ends of the string.

As a preferred example, one end of the string is fixedly connected to the hearing aid body, and the other end of the string extends along a direction away from the ear canal.

As a preferred example, the second antenna is at least partially disposed at the string.

In the present disclosure, the string is disposed to facilitate a user in removing and wearing the in-the-canal hearing aid. In addition, the second antenna is at least partially disposed at the string. The second antenna and the string are structurally combined to improve concealment of the in-the-canal hearing aid, thereby improving antenna concealment and aesthetic appeal for the hearing aid while ensuring a communication function of the second antenna. Further, the string can have a plurality of forms, making it easy to adapt to designs of the in-the-canal hearing aid in a plurality of scenarios.

As a preferred example, the second antenna is bendable at different angles.

The present disclosure sets the second antenna to have the characteristic of being bendable at different angles. In this way, the second antenna can be bent into the different radians based on communication and aesthetic requirements of different in-the-canal hearing aids, thereby ensuring both concealment and communication performance of the antenna.

As a preferred example, an external accessory is further included, where the external accessory is detachably connected to a side of the hearing aid body away from the ear canal, and the second antenna is disposed at the external accessory to achieve a detachable connection between the second antenna and the hearing aid body.

The present disclosure sets the external accessory to be detachably plugged into the hearing aid body. The second antenna is disposed inside the external accessory to achieve the detachable connection between the second antenna and the hearing aid body, thereby improving a diversity of using the second antenna and adapting to various hearing aid usage scenarios.

As a preferred example, the hearing aid body is equipped with a first contact point at a contact position with the first antenna;
the hearing aid body is equipped with a second contact point at a contact position with the second antenna;
when an external accessory is connected to the hearing aid body, the first contact point is in contact with the second contact point; and
the signal connection is established between the second antenna and the first antenna through the first contact point and the second contact point.

The present disclosure achieves a communication function of the antenna by plugging the external accessory into the hearing aid body, and disposes corresponding contact points on the external accessory and the hearing aid. A communication connection between the first antenna and the second antenna is achieved through the contact points, thereby realizing a communication function of the antenna body. The communication function of the antenna is disabled when the external accessory is not plugged into the hearing aid body, which is convenient for the user to operate and can support the various hearing aid usage scenarios.

### BRIEF DESCRIPTION OF THE DRAWINGS

FIG. 1 is a schematic diagram when an inverted-F antenna and a motherboard are not on a same plane according to an embodiment of the present disclosure;

FIG. 2 is another schematic diagram when an inverted-F antenna and a motherboard are not on a same plane according to an embodiment of the present disclosure;

FIG. 3 is a schematic diagram when an inverted-F antenna and a motherboard are on a same plane according to an embodiment of the present disclosure;

FIG. 4 is a schematic diagram of a signal connection between a loop antenna and a motherboard according to an embodiment of the present disclosure;

FIG. 5 is a schematic diagram of a signal connection between a monopole antenna and a motherboard according to an embodiment of the present disclosure;

FIG. 6 is a schematic structural diagram of an in-the-canal hearing aid according to an embodiment of the present disclosure;

FIG. 7 is a schematic diagram of a direct signal connection between a first antenna and a second antenna according to an embodiment of the present disclosure;

FIG. 8 is another schematic diagram of a direct signal connection between a first antenna and a second antenna according to an embodiment of the present disclosure;

FIG. 9 is a schematic diagram of an indirect signal connection between a first antenna and a second antenna according to an embodiment of the present disclosure;

FIG. 10 is another schematic diagram of an indirect signal connection between a first antenna and a second antenna according to an embodiment of the present disclosure;

FIG. 11 is another schematic diagram of an indirect signal connection between a first antenna and a second antenna according to an embodiment of the present disclosure;

FIG. 12 is a schematic diagram of a method for wrapping a string and a second antenna according to an embodiment of the present disclosure;

FIG. 13 is a schematic structural diagram of a second antenna used as a string and with a radian of 0 degrees according to an embodiment of the present disclosure;

FIG. 14 is a schematic structural diagram of a second antenna with a radian of 0 degrees according to an embodiment of the present disclosure;

FIG. 15 is a schematic structural diagram of a second antenna used as a string and with a radian of 70 degrees according to an embodiment of the present disclosure;

FIG. 16 is a schematic structural diagram of a second antenna with a radian of 70 degrees according to an embodiment of the present disclosure;

FIG. 17 is a schematic structural diagram of a second antenna used as a string and with a radian of exceeding 180 degrees and reaching 360 degrees according to an embodiment of the present disclosure;

FIG. 18 is a schematic structural diagram of a second antenna with a radian of exceeding 180 degrees and reaching 360 degrees according to an embodiment of the present disclosure;

FIG. 19 is a schematic structural diagram of a loop antenna used as a string according to an embodiment of the present disclosure;

FIG. 20 is a schematic structural diagram of a string with a polygonal shape according to an embodiment of the present disclosure;

FIG. 21 is a schematic structural diagram of combining an external accessory and a hearing aid body according to an embodiment of the present disclosure;

FIG. 22 is a schematic structural diagram of separating an external accessory from a hearing aid body according to an embodiment of the present disclosure;

FIG. 23 is a schematic structural diagram of an in-the-canal hearing aid containing a string and an external accessory according to an embodiment of the present disclosure;

FIG. 24 is a schematic diagram showing a shape of a string when an external accessory and a hearing aid body are combined according to an embodiment of the present disclosure;

FIG. 25 is another schematic diagram showing a shape of a string when an external accessory and a hearing aid body are combined according to an embodiment of the present disclosure;

FIG. 26 is a schematic diagram of a combined antenna according to an embodiment of the present disclosure;

FIG. 27 is another schematic diagram of an indirect signal connection between a first antenna and a second antenna according to an embodiment of the present disclosure;

FIG. 28 is a schematic structural diagram of disposing a second antenna inside a string according to an embodiment of the present disclosure; and

FIG. 29 is a schematic structural diagram of separating an external accessory from a hearing aid body according to an embodiment of the present disclosure.

1: first sub-antenna; 2: second sub-antenna; 3: first signal connection point; 4: second signal connection point; 5: third signal connection point; 6: antenna motherboard; 7: loop antenna; 8: monopole antenna; 9: earplug; 10: hearing aid body; 11: string; 12: PCB motherboard; 13: first antenna; 14: second antenna; 15: shell; 16: separation piece; 17: fixator; 18: antenna body; 19: horizontal baseline; 20: external accessory; 21: chip; 22: combined antenna; 23: first contact point; 24: second contact point.

### DETAILED DESCRIPTION

The technical solutions in the embodiments of the present disclosure are clearly and completely described below with reference to the accompanying drawings in the embodiments of the present disclosure. Apparently, the described embodiments are only some rather than all of the embodiments of the present disclosure. All other embodiments obtained by a person of ordinary skill in the art based on the embodiments of the present disclosure without creative efforts shall fall within the protection scope of the present disclosure.

### Embodiment 1

Specifically, this embodiment provides a combined antenna 22. The combined antenna 22 includes an antenna body 18 and an antenna motherboard 6. A signal connection is established between at least one end of the antenna body 18 and the antenna motherboard 6, and the antenna body 18 includes a first antenna 13 and a second antenna 14. A signal connection is established between the first antenna 13 and the antenna motherboard 6, and a signal connection is established between the second antenna 14 and the first antenna 13.

Preferably, the antenna body 18 is any one of an inverted-F antenna, a loop antenna, and a folded monopole antenna, and the signal connection between the antenna body 18 and the antenna motherboard 6, and the signal connection between the first antenna 13 and the second antenna 14 in the antenna body 18 both include a direct connection and an indirect connection.

Optionally, when the signal connection is the direct connection, based on that the antenna body 18 adopts any one of a plurality of types of antennas such as the inverted-F antenna, the loop antenna, and the folded monopole antenna, it can be learned that the direct connection between the antenna body 18 and the antenna motherboard 6 can be classified into a plurality of situations. However, in order to ensure the signal connection between the antenna body 18 and the antenna motherboard 6, the antenna body 18 is equipped with at least one signal connection node for achieving a signal connection to a chip 21 on the antenna motherboard 6, as shown in FIG. 26.

Further, in a specific process of connecting the antenna body 18 and the antenna motherboard 6, the direct connection includes a contact connection and an electrical connection. The contact connection is to make a protrusion or weld a device such as a thimble shrapnel on the antenna motherboard 6, such that this protrusion or device can be in contact with a part of the first antenna 13 to achieve the direct connection. The electrical connection is to directly weld one end of the antenna body 18 onto the antenna motherboard 6.

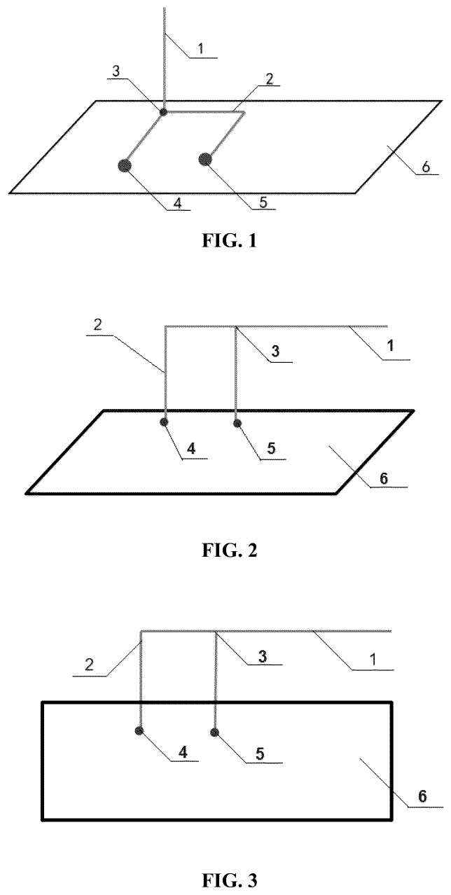

In some implementations of this embodiment, the antenna body 18 is set to the any one of the inverted-F antenna, the loop antenna, or the folded monopole antenna, such that the antenna body 18 can adapt to different antenna installation space in a plurality of types of in-the-canal hearing aids, thereby reducing space occupied by the antenna. When the signal connection between the antenna body 18 and the antenna motherboard 6 is the direct connection, an example in which the at least one end of the antenna body 18 is directly welded onto the antenna motherboard 6 to achieve the direct connection to the antenna motherboard 6 is used. FIG. 1 to FIG. 5 show structures of the direct connection between the antenna body 18 and the antenna motherboard 6.

FIG. 1 and FIG. 2 are schematic diagrams of a signal connection when the antenna body 18 is the inverted-F antenna and the antenna body 18 and the antenna motherboard 6 are not on a same plane. FIG. 3 is a schematic diagram of a signal connection when the antenna body 18 is the inverted-F antenna and the antenna body 18 and the antenna motherboard 6 are on a same plane. Referring to FIG. 1, FIG. 2, and FIG. 3, it can be seen that the antenna body 18 can have a plurality of segments, with a joint point between adjacent segments. The antenna body 18 is divided into the segments, and the segments are connected through the joint point, such that an antenna structure is not limited to an individual straight line to form various shapes of antennas, thereby meeting an antenna setup demand when the hearing aid has a small volume and small space.

Referring to FIG. 1, the antenna body 18 is the inverted-F antenna. The inverted-F antenna includes a first sub-antenna 1 and a second sub-antenna 2. The first sub-antenna 1 is disposed outside the antenna motherboard 6 and is not on a same plane as the antenna motherboard 6. The second sub-antenna 2 is in an inverted-“C” shape and is on the same plane as the antenna motherboard 6. A signal connection is established between the first sub-antenna 1 and the second sub-antenna 2 through a first signal connection point 3. A signal connection is established between the inverted-F antenna and the antenna motherboard 6. Specifically, the inverted-F antenna includes the first signal connection point 3, a second signal connection point 4, and a third signal connection point 5. The signal connection is established between the inverted-F antenna and the antenna motherboard 6 through the first signal connection point 3, the second signal connection point 4, and the third signal connection point 5.

Further, referring to FIG. 1, there are three signal connection points between the inverted-F antenna and the antenna motherboard 6. The second signal connection point 4 and the third signal connection point 5 achieve signal connections to a chip 21 on the antenna motherboard 6 and a ground terminal of the antenna motherboard 6. For one example, a signal connection is established between the second signal connection point 4 and the chip 21 on the antenna motherboard 6, and a signal connection is established between the third signal connection point 5 and the ground terminal of the antenna motherboard 6. Alternatively, for another example, a signal connection is established between the second signal connection point 4 and the ground terminal of the antenna motherboard 6, and a signal connection is established between the third signal connection point 5 and the chip 21 on the antenna motherboard 6. Preferably, the ground terminal of the antenna motherboard 6 includes a point of a ground of the antenna motherboard 6 and a zero-impedance point of the ground on the antenna motherboard, such as points of grounds of a negative pole of a battery and a microphone. The zero-impedance point of the ground is a point at which impedance between the point and the ground is less than or equal to 5 ohms through measurement. In this embodiment, the inverted-F antenna is directly connected to the antenna motherboard 6 through the first signal connection point 3, and the signal connection is established between the first sub-antenna 1 and the second sub-antenna 2 of the inverted-F antenna.

Referring to FIG. 2, the antenna body 18 is the inverted-F antenna. The inverted-F antenna includes the first sub-antenna 1 and the second sub-antenna 2. Both the first sub-antenna 1 and the second sub-antenna 2 are disposed outside the antenna motherboard 6 and are on a different plane from the antenna motherboard 6. The second sub-antenna 2 is in the inverted-“C” shape, and the signal connection is established between the first sub-antenna 1 and the second sub-antenna 2 through the first signal connection point 3. The signal connection is established between the inverted-F antenna and the antenna motherboard 6. Specifically, the signal connection is established between the inverted-F antenna and the antenna motherboard 6 through the second signal connection point 4 and the third signal connection point 5.

Specifically, referring to FIG. 2, there are two signal connection points between the inverted-F antenna and the antenna motherboard 6. The second signal connection point 4 and the third signal connection point 5 achieve the signal connections to the chip 21 on the antenna motherboard 6 and the ground terminal of the antenna motherboard 6. For one example, the signal connection is established between the second signal connection point 4 and the chip 21 on the antenna motherboard 6, and the signal connection is established between the third signal connection point 5 and the ground terminal of the antenna motherboard 6. Alternatively, for another example, the signal connection is established between the second signal connection point 4 and the ground terminal of the antenna motherboard 6, and the signal connection is established between the third signal connection point 5 and the chip 21 on the antenna motherboard 6.

Referring to FIG. 3, the inverted-F antenna includes the first sub-antenna 1 and the second sub-antenna 2. Both the first sub-antenna 1 and the second sub-antenna 2 are on the same plane as the antenna motherboard 6. The second sub-antenna 2 is in the inverted-“C” shape, and the signal connection is established between the first sub-antenna 1 and the second sub-antenna 2 through the first signal connection point 3. The signal connection is established between the inverted-F antenna and the antenna motherboard 6. Specifically, the signal connection is established between the inverted-F antenna and the antenna motherboard 6 through the second signal connection point 4 and the third signal connection point 5.

Further, referring to FIG. 3, there are two signal connection points between the inverted-F antenna and the antenna motherboard 6. The second signal connection point 4 and the third signal connection point 5 achieve the signal connections to the chip 21 on the antenna motherboard 6 and the ground terminal of the antenna motherboard 6. For one example, the signal connection is established between the second signal connection point 4 and the chip 21 on the antenna motherboard 6, and the signal connection is established between the third signal connection point 5 and the ground terminal of the antenna motherboard 6. Alternatively, for another example, the signal connection is established between the second signal connection point 4 and the ground terminal of the antenna motherboard 6, and the signal connection is established between the third signal connection point 5 and the chip 21 on the antenna motherboard 6.

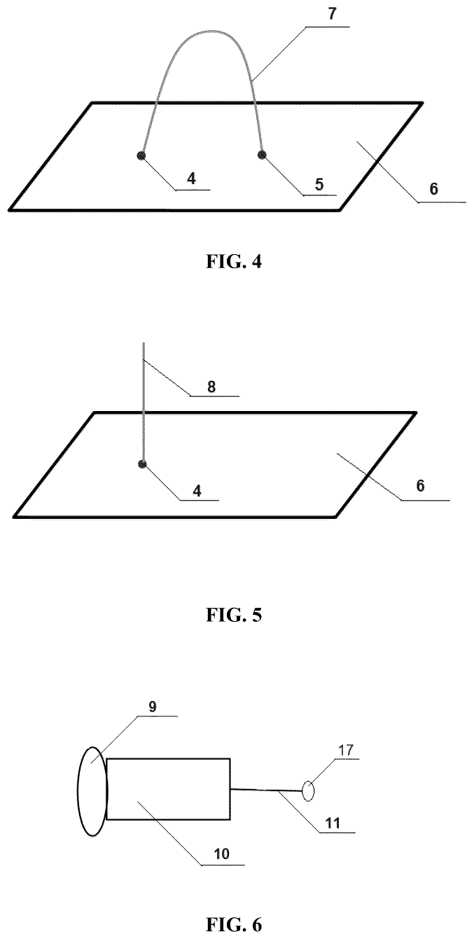

FIG. 4 is a schematic diagram when the antenna body 18 is a loop antenna 7 and the signal connection between the antenna body 18 and the antenna motherboard 6 is the direct connection. Referring to FIG. 4, the antenna body 18 is the loop antenna 7. There are two signal connection points between the loop antenna 7 and the antenna motherboard 6: the second signal connection point 4 and the third signal connection point 5. The loop antenna 7 achieves signal connections to the chip 21 on the antenna motherboard 6 and the ground terminal of the antenna motherboard 6 through the second signal connection point 4 and the third connection point 5. For one example, the signal connection is established between the second signal connection point 4 and the chip 21 on the antenna motherboard 6, and the signal connection is established between the third signal connection point 5 and the ground terminal of the antenna motherboard 6. Alternatively, for another example, the signal connection is established between the second signal connection point 4 and the ground terminal of the antenna motherboard 6, and the signal connection is established between the third signal connection point 5 and the chip 21 on the antenna motherboard 6. Optionally, the loop antenna 7 and the antenna motherboard 6 may be disposed on a same plane or on different planes based on an application scenario of the antenna.

FIG. 5 is a schematic diagram when the antenna body 18 is a monopole antenna 8 and the signal connection between the antenna body 18 and the antenna motherboard 6 is the direct connection. Referring to FIG. 5, FIG. 5 includes the monopole antenna 8, the antenna motherboard 6, and a signal connection point 4 for a signal connection between the monopole antenna 8 and the antenna motherboard 6. There is one signal connection point between the monopole antenna 8 and the antenna motherboard 6. A signal connection is established between the monopole antenna 8 and the chip 21 on the antenna motherboard 6 through the signal connection point 4. Optionally, the monopole antenna 8 and the antenna motherboard 6 may be disposed on a same plane or on different planes based on the application scenario of the antenna.

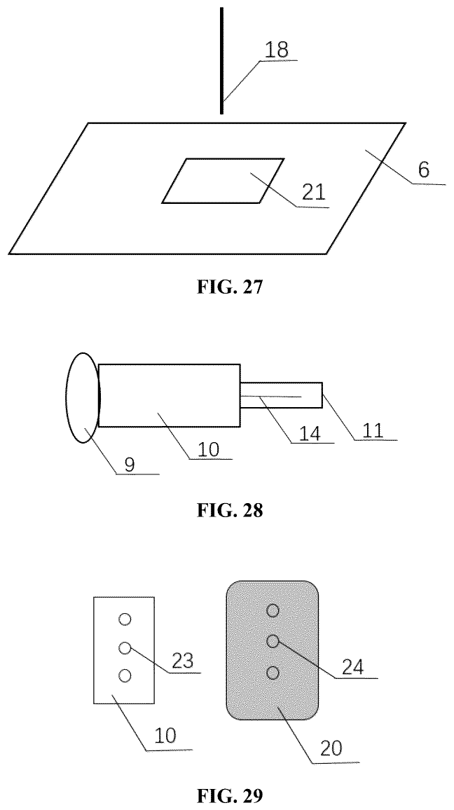

In other implementations of this embodiment, as shown in FIG. 27, the signal connection between the antenna body 18 and the antenna motherboard 6 is set to the indirect connection. When the signal connection is the indirect connection, there is a distance left between the antenna body 18 and the antenna motherboard 6, and a coupling connection is established between the antenna body 18 and the antenna motherboard 6 through a high-frequency signal. Preferably, a circuit can be disposed on the antenna motherboard 6 to provide the high-frequency signal, so as to achieve the coupling connection between the antenna body 18 and the antenna motherboard 6 through the indirect connection. The distance left between the antenna body 18 and the antenna motherboard 6 is preferably between 0 mm to 10 mm to ensure an optimal effect of the coupling connection.

Further, a coupling connection may also be achieved between the first antenna 13 and the second antenna 14 through the indirect connection. When the first antenna 13 is indirectly connected to the second antenna 14, a separation piece 16 that is non-conductive can be disposed between the first antenna 13 and the second antenna 14 to assist in positioning and fixing a connection position between the first antenna 13 and the second antenna 14. The separation piece 16 that is non-conductive and disposed in the middle can fix an antenna coupling position to achieve better connection stability, while making a signal more stable and improving communication performance of the antenna.

In some antenna application methods described in this embodiment, the antenna body 18 described in this embodiment can be applied to an in-the-canal hearing aid with the antenna motherboard 6. The in-the-canal hearing aid further includes a hearing aid body 10. In a process of applying the antenna body to the in-the-canal hearing aid, a signal connection is established between one end of the first antenna 13 of the antenna body 18 and the antenna motherboard 6 inside the hearing aid body 10, and the first antenna 13 is disposed inside the hearing aid body 10 of the in-the-canal hearing aid. The second antenna 14 in the antenna body 18 is disposed outside the hearing aid body 10 of the in-the-canal hearing aid. A signal connection is established between one end of the second antenna 14 and the first antenna 13, and the other end of the second antenna 14 is far away from the antenna motherboard 6. The signal connection includes the direct connection and the indirect connection. Preferably, in some implementations, the first antenna 13 located inside the hearing aid body 10 of the in-the-canal hearing aid can be named as an internal antenna to indicate that the first antenna 13 is disposed inside the hearing aid. Further, the second antenna 14 located outside the hearing aid body 10 of the in-the-canal hearing aid can be named as an external antenna to indicate that the second antenna 14 is disposed outside the hearing aid.

Optionally, when the in-the-canal hearing aid uses the first antenna 13 and the second antenna 14 for signal transmission, a signal connection point can be disposed to weld the first antenna 13 and the second antenna 14 together to directly connect the first antenna 13 and the second antenna 14. When the first antenna 13 is installed on the in-the-canal hearing aid, a shape of the first antenna 13 may be a straight line, another shape, or a curve with a plurality of bending angles with different degrees. The first antenna 13 may be disposed away from an inner wall of a shell of the in-the-canal hearing aid, or may be disposed along the inner wall of the shell of the in-the-canal hearing aid. Further, a shape of the second antenna 14 may be a straight line, an arc, or a curve with a plurality of bending angles with different degrees.

In addition, a circuit can be disposed on the in-the-canal hearing aid to provide a high-frequency signal to the first antenna 13, such that the first antenna 13 is indirectly connected to the second antenna 14. In a process of implementing the indirect connection, there is a spacing distance between the first antenna 13 and the second antenna 14. The spacing distance may be a thickness of the shell of the in-the-canal hearing aid, and the spacing distance preferably ranges from 0 mm to 10 mm to ensure the optimal effect of the coupling connection. Alternatively, the separation piece 16 may be disposed between the second antenna 14 and the first antenna 13 to achieve positional alignment between the second antenna 14 and the first antenna 13, thereby ensuring a connection effect. The separation piece 16 may be any lightweight non-conductive material with a high dielectric constant, which ensures antenna performance without adding a significant weight to the in-the-canal hearing aid.

In some other implementations of this embodiment, when the combined antenna 22 is applied to a device with a small device volume but a need to meet high antenna performance, such as the in-the-canal hearing aid, the first antenna 13 of the combined antenna 22 is disposed inside the device, and the second antenna 14 of the combined antenna 22 is disposed outside the device. The design method in which the combined antenna 22 is partially disposed outside the device can achieve optimal antenna performance even in the case of the small device volume.

Further, in a process of applying the combined antenna 22 to the device, the combined antenna 22 may be any one of the inverted-F antenna, the loop antenna, or the folded monopole antenna, and a signal connection between the combined antenna 22 and the antenna motherboard 6 may be set to the direct connection and the indirect connection.

In a specific application process, based on that different antenna types have different specific implementations, flexibility of disposing the antenna inside the in-the-canal hearing aid can be further improved by providing diverse connection methods between the first antenna 13 and the second antenna 14 in the antenna body 18. In addition, a characteristic that the second antenna 14 may be directly or indirectly connected to the first antenna 13 is utilized to make the combined antenna 22 adapt to different types of communication needs and ensure the communication performance of the antenna.

### Embodiment 2

This embodiment provides an in-the-canal hearing aid. FIG. 6 structurally shows the in-the-canal hearing aid, including an earplug 9, a hearing aid body 10, a string 11, and the combined antenna 22 as described in Embodiment 1. The combined antenna 22 includes a first antenna 13 and a second antenna 14. The first antenna 13 is disposed inside the hearing aid body 10, the second antenna 14 is disposed outside the hearing aid body 10, one end of the earplug 9 is connected to the hearing aid body 10, the other end of the earplug 9 is inserted into an ear canal of a user, and a main control board is disposed inside the hearing aid body 10. In this embodiment, the main control board is a PCB motherboard 12. Preferably, in this embodiment, an antenna motherboard 6 is integrated on the PCB motherboard 12, and a signal connection is established between the first antenna 13 and the antenna motherboard 6 integrated on the PCB motherboard 12 to implement a communication function. Preferably, the PCB motherboard 12 is disposed inside the hearing aid body 10, and a specific position is not limited. The PCB motherboard 12 is a core of the hearing aid and is configured to implement all functions of the hearing aid. The PCB motherboard 12 is equipped with a circuit, a chip, a power supply, and the like for achieving an electrical connection to another component to achieve a specific function. Preferably, in this embodiment, the antenna motherboard 6 is integrated on the PCB motherboard 12, and the signal connection is established between the first antenna 13 and the antenna motherboard 6 integrated on the PCB motherboard 12 to implement the communication function. Preferably, the PCB motherboard 12 is disposed inside the hearing aid body 10, and the specific position is not limited.

Specifically, a signal connection is established between one end of the first antenna 13 and the PCB motherboard 12, and a signal connection is established between the other end of the first antenna 13 and the second antenna 14. One end of the string 11 passes through the hearing aid body 10 and is connected to the hearing aid body 10, and the other end of the string 11 extends along a direction away from the ear canal. Preferably, a tail end of the string 11 is connected to a fixator 17, which is configured to facilitate grasping and positioning when the user pulls the string 11 to remove and wear the in-the-canal hearing aid.

Optionally, the signal connection between the first antenna 13 and the second antenna 14 includes a direct connection and an indirect connection.

In some implementations of this embodiment, when the signal connection between the first antenna 13 and the second antenna 14 is the direct connection, a shell 15 of the hearing aid body 10 is provided with a connection port at a connection point. One end of the second antenna 14 passes through the connection port and is welded with one end that is of the first antenna 13 and fixed on an inner wall of the shell 15 of the hearing aid body 10, and the other end of the second antenna 14 is disposed outside the shell 15 of the hearing aid body 10.

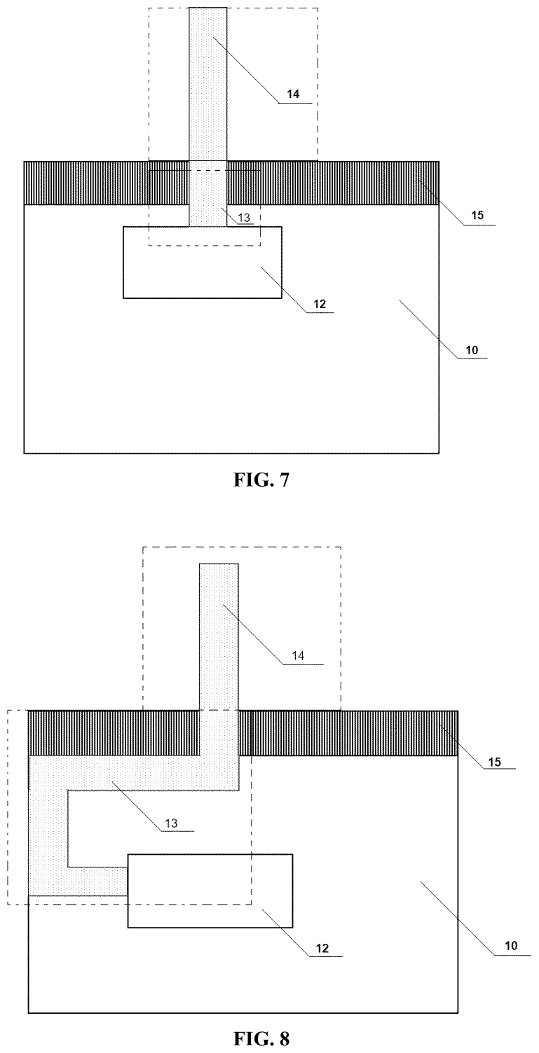

Specifically, FIG. 7 and FIG. 8 are schematic diagrams when the signal connection between the second antenna 14 and the first antenna 13 is the direct connection in this embodiment. In FIG. 7 and FIG. 8, dashed boxes correspond to the second antenna 14 and the first antenna 13, respectively. The second antenna 14 in the dashed box is located outside the shell 15, and the first antenna 13 in the dashed box is located inside the shell 15. Further, FIG. 7 and FIG. 8 also include the hearing aid body 10, the shell 15 of the hearing aid body 10, and the PCB motherboard 12 disposed inside the hearing aid body. The PCB mother board 12 is integrated with the antenna motherboard 6. Referring to FIG. 7 and FIG. 8, it can be seen that the second antenna 14 and the first antenna 13 may be an integrated antenna; or the second antenna 14 and the first antenna 13 may be two separate antenna segments. A connection port is also provided on the shell 15 of the hearing aid body 10, and the second antenna 14 and the first antenna 13 are directly welded together through the connection port to form the combined antenna 22. The first antenna 13 may extend directly from a direction in which the shell 15 is away from the hearing aid body 10, and an antenna located outside the shell 15 serves as the second antenna 14. The first antenna 13 may alternatively have a plurality of bending angles along the inner wall of the shell 15 and extend to an outside, and an antenna located outside the well 15 serves as the second antenna 14. A shape of the first antenna 13 may be a straight line or a curve, and a plurality of bending angles may further be included, with no limitation on a quantity of bending angles and a quantity of degrees of the bending angle. Preferably, the shape of the first antenna 13 and a shape of the second antenna 14 may be different, and specific shapes can be determined based on a product design.

Further, in some implementations of this embodiment, the first antenna 13 inside the shell 15 and the second antenna 14 outside the shell 15 can be directly welded together, where inner widths and outer widths of the first antenna 13 and of the second antenna 14 may or may not be the same. When the inner widths and the outer widths of the second antenna 14 are the same, a manufacturing process is simple and a cost is low. When the inner widths and the outer widths of the second antenna 14 are not the same, a width of the second antenna 14 can be appropriately narrowed while antenna performance is met, so as to provide aesthetic appeal for the hearing aid while ensuring performance of the second antenna 14 on a premise of ensuring connection stability of the first antenna 13. If the second antenna 14 is too thick or too long, shielding performance will be affected. If the second antenna 14 is too thin or too short, antenna impedance increases, thereby affecting the antenna performance. Preferably, in this embodiment, a length and a width of the second antenna 14 that is of the combined antenna 22 and located outside the shell 15 are set to 8 mm to 20 mm and 0.03 mm to 2 mm, respectively, which can ensure both the shielding performance and the antenna performance.

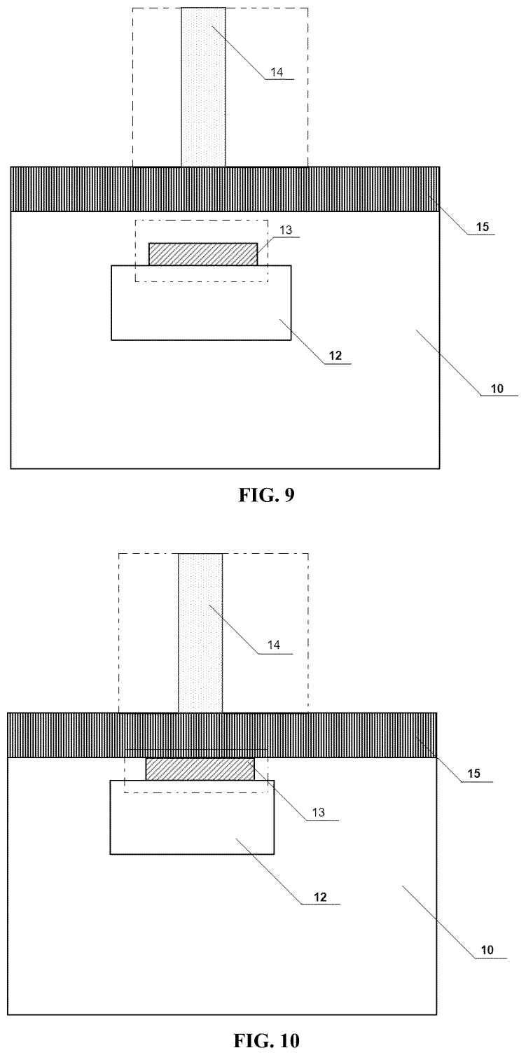

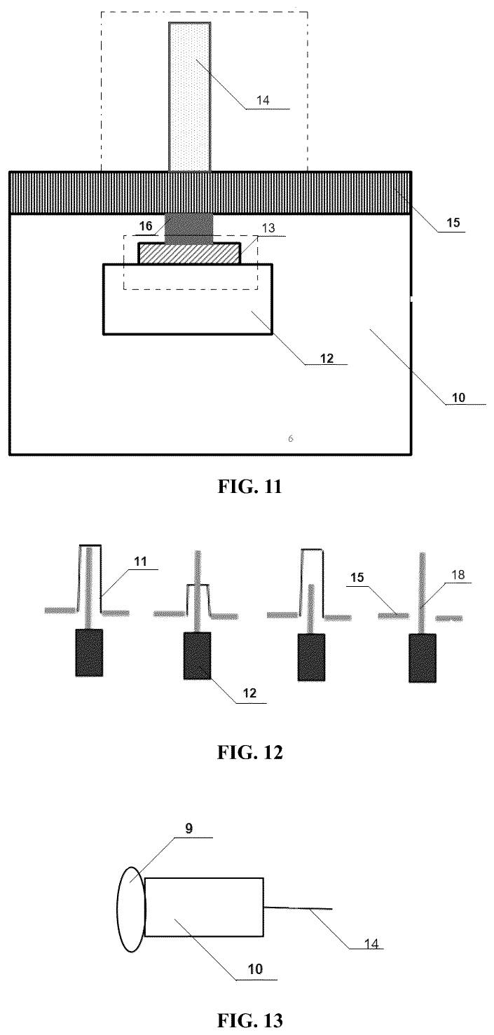

In some other implementations of this embodiment, FIG. 9, FIG. 10, and FIG. 11 are a plurality of corresponding schematic diagrams when the signal connection between the second antenna 14 and the first antenna 13 is the indirect connection. In FIG. 9, FIG. 10, and FIG. 11, dashed boxes correspond to the second antenna 14 and the first antenna 13, respectively. The second antenna 14 in the dashed box is located outside the shell 15, and the first antenna 13 in the dashed box is located inside the shell 15. Referring to FIG. 9 and FIG. 10, no connection port is provided on the shell 15, and the first antenna 13 is tightly attached to the inner wall of the shell 15 or separated from the inner wall of the shell 15 by a certain distance. The signal connection is established between the one end of the first antenna 13 and the PCB motherboard 12. The PCB motherboard 12 is integrated with the antenna motherboard 6. The other end of the first antenna 13 is not directly connected to the second antenna 14 and is separated from the second antenna 14 by a certain distance. The in-the-canal hearing aid also includes a built-in high-frequency circuit for providing a high-frequency signal to the first antenna 13, such that an indirect coupling connection is established between the first antenna 13 and the second antenna 14 through the high-frequency signal.

Further, referring to FIG. 11, in order to achieve better and more stable communication performance of the combined antenna, a separation piece 16 that is non-conductive and has a high dielectric constant is disposed between the second antenna 14 and the first antenna 13. One end of the separation piece 16 that is non-conductive is tightly attached to the inner wall of the shell 15, and the other end is tightly attached to the first antenna 13. The second antenna 14 is tightly attached to an outer wall of the shell 15. The second antenna 14 and the first antenna 13 are connected without direct contact, but communicate with each other through the indirect coupling connection by using the high-frequency signal provided by the high-frequency circuit. The separation piece 16 that is non-conductive and has a high dielectric constant is disposed between the second antenna 14 and the first antenna 13 to ensure position alignment and fix positions of the second antenna 14 and the first antenna 13, thereby achieving better and more stable communication performance when the first antenna 13 and the second antenna 14 are indirectly connected.

Optionally, referring to a schematic structural diagram of the in-the-canal hearing aid shown in FIG. 6, due to a small volume of the in-the-canal hearing aid, it is inconvenient to remove the earplug after inserting the earplug into an ear. Therefore, in the in-the-canal hearing aid, the string 11 is often disposed on the hearing aid body 10 as an external pull line, such that the in-the-canal hearing aid is pulled out of the ear canal with the help of the string 11 on the hearing aid body 10, making it convenient for the user to remove and wear the in-the-canal hearing aid. At least one end of the string 11 is fixedly connected to the hearing aid body 10, and a shape of the string 11 is not limited and may be a straight line or other shapes. For example, referring to FIG. 13, the string 11 may be the straight line. Referring to FIG. 20, the string 11 may alternatively be a trapezoidal flat piece, which is convenient for adapting to designs of the in-the-canal hearing aid in a plurality of scenarios. The second antenna 14 of the combined antenna 22 may be at least partially disposed inside the string 11, as shown in FIG. 28. Alternatively, the second antenna 14 of the combined antenna may directly serve as the string 11 to achieve a function of removing and wearing the in-the-canal hearing aid. In this case, the in-the-canal hearing aid may not be additionally equipped with the string 11, as shown in FIG. 13. The second antenna 14 is at least partially disposed at the string 11 to structurally combine the second antenna 14 and the string 11, which can improve concealment of the in-the-canal hearing aid, thereby achieving better antenna concealment and aesthetic appeal for the hearing aid while ensuring a communication function of the second antenna 14.

In some implementations of this embodiment, the second antenna 14 is made of a metal material, and the string 11 is made of a non-metal material. Referring to FIG. 12, the string 11 can at least partially wrap the second antenna 14 exposed to the shell 15. A specific wrapping method may include full wrapping and half wrapping. The full wrapping provides better protection for the second antenna 14, thereby preventing possible corrosion due to sufficient contact between the second antenna 14 and air outside the shell 15 from affecting durability of the antenna. The half wrapping has a better antenna clearance effect than the full wrapping. The string 11 may also not wrap the second antenna 14 exposed to the in-the-canal shell 15, allowing the second antenna 14 to obtain a great clearance, thereby improving antenna performance. In addition, the string 11 may be made of a plastic material or a polymer material, may be made of one or more materials such as polyether block amide or other thermoplastic elastomers, or may be made of a reinforced fiber such as an aromatic polyamide fiber, which can ensure both elasticity and rigidity, achieve bendability, and provide rigid protection for the antenna.

Further, as shown in FIG. 12, the PCB motherboard 12 (integrated with the antenna motherboard 6), the string 11, the shell 15, and the antenna body 18 are included. The antenna body 18 can extend towards a direction away from the hearing aid body 10 along an inside of the string 11. A length of the antenna body 18 can be almost equal to or shorter than a length of the string 11. An external pull line formed by the string 11 and the antenna body 18 may be straight or curved. A bending radian of the external pull line formed by the string 11 and the antenna body 18 is related to the antenna performance. Further, the total length of the string 11 is within 35 mm.

In some implementations of this embodiment, when the second antenna 14 is at least partially disposed in the string 11 or exists alone to serve as the string 11, the second antenna 14 is bendable at different angles. The radian is a radian of an included angle between the second antenna 14 and a horizontal baseline 19 when a centerline of the body of the in-the-canal hearing aid is used as the horizontal baseline 19.

Specifically, referring to FIG. 13, when a radian of the second antenna 14 used as the string 11 is 0 degrees, best antenna performance is achieved, but concealment of the second antenna 14 in the ear canal of the user is the worst, and there is a significant power consumption. Compared with an in-the-canal hearing aid with the antenna completely disposed inside the hearing aid body 10 in the industry, the second antenna 14 with the radian of 0 degrees can improve its performance by 20 dB. When the radian of the second antenna 14 ranges from 70 degrees to 130 degrees, both good antenna performance and good concealment of the second antenna 14 in the ear canal of the user can be ensured. Specifically, referring to FIG. 15, when the radian of the second antenna 14 is 70 degrees, the second antenna 14 can be better attached to a contour of the ear canal of the user. In addition, compared with the in-the-canal hearing aid with the antenna completely disposed inside the hearing aid body 10 in the industry, the second antenna 14 with the radian of 70 degrees can improve its performance by 10 dB.

Referring to FIG. 17, when the radian of the second antenna 14 exceeds 180 degrees and reaches around 360 degrees, that is, when the second antenna 14 winds one circle, better antenna concealment can be achieved compared with antenna concealment achieved when the radian of the second antenna 14 is 0 degree, and better antenna performance can be achieved compared with antenna performance achieved when the radian of the second antenna 14 is 180 degrees.

Further, due to flexibility of the second antenna 14, antenna performance in different scenarios can be achieved by adjusting the string 11 to different radians. A smaller radian of the second antenna 14 leads to better antenna performance, which is more suitable for mutual communication between hearing aids of left and right human ears or a communication connection to a device that is physically far away (such as a television far away from the hearing aid). However, a high power consumption and poor antenna concealment are caused. A larger radian of the second antenna 14 leads to poorer antenna performance but a lower power consumption and better antenna concealment, which is suitable for a usage scenario in which a mobile phone is connected or the hearing aid is used as a wireless device. Therefore, the user can adjust the second antenna 14 or the string 11 including the second antenna 14 to be relatively straight and have a small radian when communication between binaural hearing aids is required. When the mobile phone needs to be connected, the second antenna 14 or the string 11 including the second antenna 14 can be bent into a large radian, thus comprehensively balancing a power consumption of the hearing aid, improving user experience, and extending use time of the hearing aid while meeting the antenna performance in the different usage scenarios.

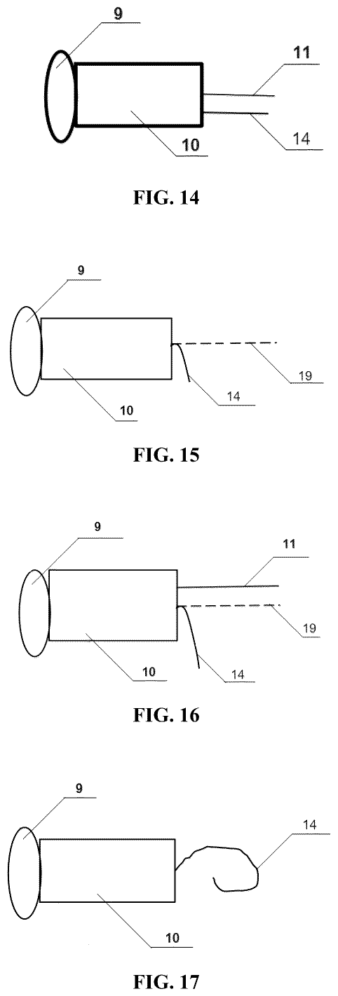

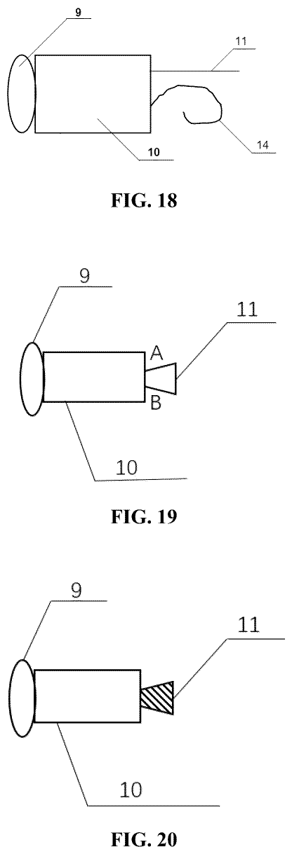

In some other implementations of this embodiment, the second antenna 14 may not be disposed in the string 11. Specifically, although the second antenna 14 is disposed outside the shell 15, the second antenna 14 is independent of the string 11. In this case, the second antenna 14 may not be wrapped with an external material or may be fully or half wrapped with a corrosion-resistant external material. The in-the-canal hearing aid is also separately provided with the string 11 for pulling the in-the-canal hearing aid. In this case, referring to FIG. 14, FIG. 16, and FIG. 18, up, down, left, and right relative positions of the second antenna 14 and the string 11 are not limited. The string 11 may be disposed above the second antenna 14 or below the second antenna 14, or positions of the string 11 and the second antenna 14 may be set to be on different horizontal lines. The length of the string 11 and a length of the second antenna 14 are not limited, either. The second antenna 14 may be shorter than, equal to, or longer than the string 11. Shapes of the string 11 and second antenna 14 are not limited, either.

Preferably, when the second antenna 14 is at least partially disposed in the string 11, or when the second antenna 14 serves as the string 11 for pulling the in-the-canal hearing aid, the shape of the second antenna 14 is not limited. For example, as shown in FIG. 13, when the antenna body 18 is a monopole antenna or an inverted-F antenna, the shape of the second antenna 14 (which can also be the string 11) may be a straight line. In this case, one end of the second antenna 14 (which can also be the string 11) is fixedly connected to the hearing aid body 10 of the in-the-canal hearing aid, and the other end is disposed away from the hearing aid body 10 of the in-the-canal hearing aid (namely, a direction of the ear canal). For another example, as shown in FIG. 19, when the antenna body 18 is a loop antenna, the shape of the second antenna 14 (which can also be the string 11 including the second antenna 14) may be an arc or a polygon. In this case, head and tail ends of the second antenna 14 (which can also be the string 11 including the second antenna 14) are fixedly connected to the hearing aid body 10 of the in-the-canal hearing aid, and fixed connection points of the head and tail ends are points A and B on the shell 15. The second antenna 14 between the points A and B has a protrusion that can extend to an outside of the hearing aid body 10 of the in-the-canal hearing aid.

Preferably, as shown in FIG. 6, the string 11 is disposed on a surface of the hearing aid body 10 away from the ear canal. The string 11 may be located on an upper/middle/lower part of the surface away from the ear canal, or close to or far from an inner wall of a cavity of auricular concha, or close to an earlobe or an antihelix, and a specific position is not limited. One end of the string 11 away from the hearing aid body 10 can be equipped with a fixator 17, and a specific shape is not limited. Preferably, a cross-sectional size of the fixator 17 is larger than that of the string 11. The fixator 17 has a spherical protrusion, making it easy for the user to grasp the string 11 when taking and pulling the hearing aid. This prevents a failure to pull the hearing aid out of the ear canal because it is difficult to perform positioning due to slippery hand feeling of the string 11. Further, a sensor and other components can be disposed on the fixator 17 to expand a function of the in-the-canal hearing aid.

In this embodiment, the in-the-canal hearing aid including the combined antenna is disposed. The combined antenna includes the first antenna 13 disposed inside the shell 15 and the second antenna 14 disposed outside the shell 15. The first antenna 13 and the second antenna 14 can communicate with each other through the signal connection such as the direct connection and the indirect connection. The antenna design is not limited to the body of the in-the-canal hearing aid, which meets a requirement that the in-the-canal hearing aid has a small device volume and small space but needs to ensure the antenna performance. The second antenna 14 can be at least partially disposed on the string 11 used for removing and wearing the in-the-canal hearing aid. The string 11 may partially wrap or not wrap the antenna, and the second antenna 14 may also exist separately from the string 11, which ensures the concealment of the antenna in the ear canal and the aesthetic appeal for the hearing aid and improves customer experience while meeting the antenna performance. In addition, the shape of the first antenna 13 may be the straight line or a curve of another shape. The first antenna 13 may be attached to the inner wall of the shell 15 or be away from the inner wall of the shell 15. The second antenna 14 can be bent into various arcs to achieve different antenna performance, which can adapt to different practical application scenarios and product design requirements, thereby achieving a wide application range and strong scalability.

### Embodiment 3

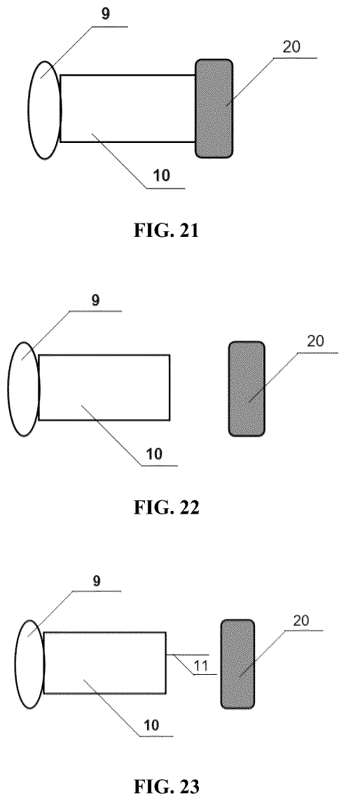

This embodiment provides an in-the-canal hearing aid. FIG. 21 and FIG. 22 structurally show the in-the-canal hearing aid, including an earplug 9, a hearing aid body 10, an external accessory 20, and the combined antenna as described in Embodiment 1. The combined antenna includes a first antenna 13 and a second antenna 14. The first antenna 13 is disposed inside the hearing aid body 10. The second antenna 14 is disposed in the external accessory 20. The external accessory 20 is detachably connected to a side of the hearing aid body 10 away from an ear canal, thereby realizing a detachable connection between the second antenna 14 and the hearing aid body 10. One end of the earplug 9 is connected to the hearing aid body 10, and a main control board is disposed inside the hearing aid body 10. In this embodiment, the main control board is a PCB motherboard 12. Preferably, in this embodiment, an antenna motherboard 6 is integrated on the PCB motherboard 12, and a signal connection is established between the first antenna 13 and the antenna motherboard 6 integrated on the PCB motherboard 12 to implement a communication function. Preferably, the PCB motherboard 12 is disposed inside the hearing aid body 10, and a specific position is not limited. Further, a signal connection between the second antenna 14 and the first antenna 13 includes a direct connection and an indirect connection. The signal connection between the first antenna 13 and the antenna motherboard 10 includes a direct connection and an indirect connection. Preferably, when the signal connection is established between the second antenna 14 and the first antenna 13 through the external accessory 20, if the first antenna 13 is directly connected to the PCB motherboard 12 (integrating the antenna motherboard 6) and is indirectly connected to the second antenna 14 on the external accessory 20, a contact surface for connecting the external accessory 20 and the hearing aid body 10 can be set to a specific shape for matching or a corresponding locking matching structure to achieve position fixation when the antenna is indirectly connected. This prevents a failure to trigger an antenna function due to an incorrect position of the contact surface between the external accessory 20 and the hearing aid body 10.

Preferably, the external accessory 20 is equipped with a connection fixing structure that cooperates with the hearing aid body 10. The connection fixing structure includes but is not limited to a buckle, a magnet, and other structures, which facilitates accurate alignment and connection stability when the external accessory 20 is connected to the hearing aid body 10, thereby achieving precise alignment and connection between the second antenna 14 and the first antenna 13, and ensuring antenna performance. If the first antenna 13 is directly connected to the second antenna 14 on the external accessory 20, contact points are disposed on the external accessory 20 and the hearing aid body 10 to achieve alignment after the contact to trigger a communication function of the antenna, respectively. Specifically, as shown in FIG. 29, a first contact point 23 is provided at a contact position between the hearing aid body 10 and the first antenna 13, and a second contact point 24 is provided at a contact position between the second antenna 14 and the external accessory 20. When the external accessory 20 is connected to the hearing aid body 10, the first contact point 23 and the second contact point 24 are in contact, and the signal connection is established between the second antenna 14 and the first antenna 13 through the first contact point 23 and the second contact point 24.

Preferably, the contact point is a metal contact point. In a process of disposing the metal contact point, different quantities of metal contact points are disposed based on a type of the first antenna 13. When the first antenna 13 is an inverted-F antenna, the external accessory 20 and the hearing aid body 10 each are provided with at least one metal contact point. When the first antenna 13 is a loop antenna, the external accessory 20 and the hearing aid body 10 each are provided with two metal contact points. When the first antenna 13 is a monopole antenna, the external accessory 20 and the hearing aid body 10 each are provided with one metal contact point.

In this embodiment, the signal connection between the second antenna 14 and the first antenna 13 is achieved by separately disposing the metal contact point on the external accessory 20 and the hearing aid body 10 to make the external accessory 20 come into contact with the hearing aid body 10, so as to trigger the communication function of the antenna.

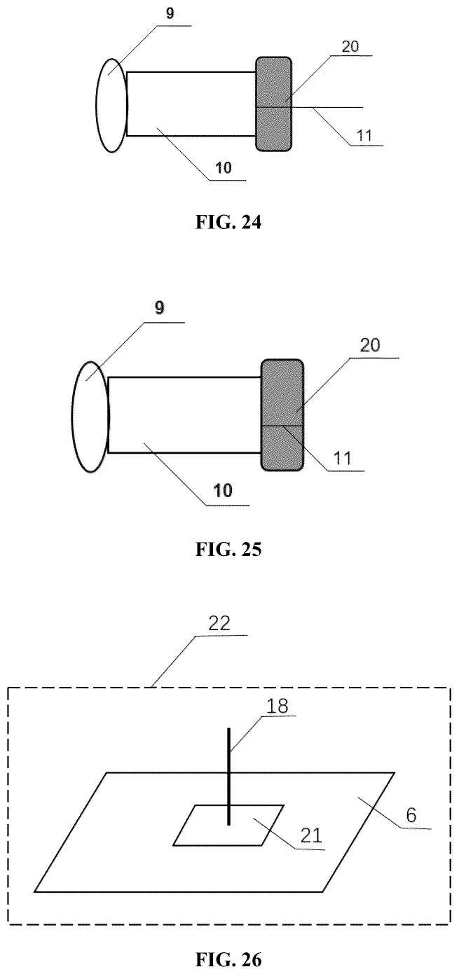

Optionally, referring to FIG. 23, FIG. 24, and FIG. 25, a string 11 can also be disposed in the in-the-canal hearing aid. The string 11 does not include the second antenna 14, and a length of the string 11 is not limited. The second antenna 14 is disposed in the external accessory 20. The external accessory 20 also includes a hole whose shape and size match a cross-sectional shape and size of the string 11.

Referring to FIG. 23, when the external accessory 20 is not connected to the hearing aid body 10, one end of the string 11 is connected to the hearing aid body 10, and the other end of the string 11 extends along a direction away from the ear canal. In this case, the external accessory 20 is not connected to the hearing aid body 10, a wireless function of the antenna is not triggered, and the in-the-canal hearing aid is in a flight mode and does not support a wireless communication function.

Referring to FIG. 24, the length of the string 11 may exceed a cross-sectional width of the external accessory 20. When the external accessory 20 is connected to the hearing aid body 10, the string 11 can be plugged into the external accessory 20. Specifically, when the external accessory 20 is connected to the hearing aid body 10, the one end of the string 11 is connected to the hearing aid body 10, and the other end of the string 11 passes through the hole of the external accessory 20 and extends along the direction away from the ear canal. In this case, the external accessory 20 is connected to the hearing aid body 10, such that the signal connection is established between the first antenna 13 inside the hearing aid body 10 and the second antenna 14 inside the external accessory 20 to trigger the antenna performance of the in-the-canal hearing aid. In this case, the in-the-canal hearing aid supports the wireless communication function.

Referring to FIG. 25, the length of the string 11 may not exceed the cross-sectional width of the external accessory 11. When the external accessory 20 is connected to the hearing aid body 10, the string 11 can be plugged into the external accessory 20. Specifically, when the external accessory 20 is connected to the hearing aid body 10, the one end of the string 11 is connected to the hearing aid body 10, and the other end of the string 11 extends along the direction away from the ear canal and is plugged into the external accessory 20 through the hole of the external accessory 20. In this case, the external accessory 20 is connected to the hearing aid body 10, such that the signal connection is established between the first antenna 13 inside the hearing aid body 10 and the second antenna 14 inside the external accessory 20 to trigger the antenna performance of the in-the-canal hearing aid. In this case, the in-the-canal hearing aid supports the wireless communication function.

Preferably, both a surface of the string 11 and a surface of the hole are covered with an anti-slip material such as a frosted material to increase friction force during connection, thereby further ensuring a stable connection between the hearing aid body 10 and the external accessory 20 through the string 11.

In this embodiment, the in-the-canal hearing aid including the combined antenna is disposed. The combined antenna includes the first antenna 13 disposed inside the shell 15 and the second antenna 14 disposed outside the shell 15. The first antenna 13 and the second antenna 14 can communicate with each other through the signal connection such as the direct connection and the indirect connection. The antenna design is not limited to the body of the in-the-canal hearing aid, which meets a requirement that the in-the-canal hearing aid has a small device volume and small space but needs to ensure the antenna performance. The first antenna 13 is disposed in the body of the in-the-canal hearing aid, and the second antenna 14 is disposed inside the external accessory that is detachably connected to the in-the-canal hearing aid. When the external accessory is connected to the hearing aid body 10, the signal connection between the first antenna 13 and the second antenna 14 is achieved, thereby triggering the antenna performance of the in-the-canal hearing aid and enabling the in-the-canal hearing aid to support the wireless communication function. When the external accessory 20 is separated from the hearing aid body 10, the first antenna 13 and the second antenna 14 are disconnected, and the wireless communication function of the in-the-canal hearing aid is disabled. This makes it possible for the user to use the in-the-canal hearing aid in a plurality of scenarios (including scenarios in which the wireless communication function of the in-the-canal hearing aid needs to and/or does not need to be used), thereby achieving a wide application range and good user experience. In addition, the contact point or a connection matching structure is disposed on the external accessory 20 and the hearing aid body 10, and the signal connection between the second antenna 14 and the first antenna 13 is achieved through the direct direction or the indirect connection, thereby meeting various design needs for the antenna of the in-the-canal hearing aid. In addition, the string 11 that does not include the second antenna 14 is disposed on the hearing aid body 10 and is plugged into the external accessory 20. This can assist the user in removing the in-the-canal hearing aid through the string 11, and the string 11 has a certain auxiliary fixing effect on the connection between the external accessory 20 and the hearing aid body 10.

In the combined antenna and the in-the-canal hearing aid using the combined antenna provided in the embodiments disclosed in the present disclosure, the antenna is at least partially disposed outside the shell 15 of the hearing aid body 10 of the in-the-canal hearing aid to enhance and expand the antenna performance, avoid a problem that the in-the-canal hearing aid cannot provide enough space to place the component due to a small internal volume thereof, enable the antenna to obtain a better clearance, reduce shielding of the antenna by other components, and achieve better antenna performance. In addition, the hearing aid body 10 of the in-the-canal hearing aid is small in size, and the antenna is disposed on the string 11 outside the hearing aid body 10 or on the external accessory 20, thereby saving internal space of the in-the-canal hearing aid. The string 11 is shared with the antenna, or the antenna is directly used to replace the string 11, such that superior antenna performance is achieved. Alternatively, the antenna is disposed on the external accessory 20, and the external accessory 20 is plugged into the hearing aid to achieve the communication function of the antenna, thereby meeting various applicable scenarios.

The objectives, technical solutions, and beneficial effects of the present disclosure are further described in detail through the above specific embodiments. It should be understood that the above are merely some specific embodiments of the present disclosure, but are not intended to limit the protection scope of the present disclosure. It should be particularly noted that, any modifications, equivalent substitutions, improvements, and the like made by those skilled in the art within the spirit and principle of the present disclosure should be included within the protection scope of the present disclosure.

1. A combined antenna, comprising an antenna body and an antenna motherboard, wherein
a signal connection is established between at least one end of the antenna body and the antenna motherboard;
the antenna body comprises a first antenna and a second antenna;
a signal connection is established between the first antenna and the antenna motherboard; and
a signal connection is established between the second antenna and the first antenna.

2. The combined antenna according to claim 1, wherein the antenna body is any one of an inverted-F antenna, a loop antenna, and a folded monopole antenna.

3. The combined antenna according to claim 1, wherein the signal connection between the antenna body and the antenna motherboard comprises a direct connection and an indirect connection.

4. The combined antenna according to claim 3, wherein the indirect connection is a coupling connection between the antenna body and the antenna motherboard through a high-frequency signal.

5. The combined antenna according to claim 3, wherein the antenna body is equipped with at least one signal connection node for achieving a signal connection to a chip on the antenna motherboard when the antenna body is directly connected to the antenna motherboard.

6. The combined antenna according to claim 1, wherein the signal connection between the first antenna and the second antenna comprises a direct connection and an indirect connection.

7. An in-the-canal hearing aid, comprising an earplug, a hearing aid body, and the combined antenna according to claim 1, wherein
the earplug is fixedly connected to the hearing aid body; the hearing aid body is internally equipped with a main control board, and an antenna motherboard of the combined antenna is integrated on the main control board; a first antenna of the combined antenna is disposed inside the hearing aid body; and a second antenna of the combined antenna is disposed outside the hearing aid body, and a signal connection is established between the second antenna and the first antenna.

8. An in-the-canal hearing aid, comprising an earplug, a hearing aid body, and the combined antenna according to claim 2, wherein
the earplug is fixedly connected to the hearing aid body; the hearing aid body is internally equipped with a main control board, and an antenna motherboard of the combined antenna is integrated on the main control board; a first antenna of the combined antenna is disposed inside the hearing aid body; and a second antenna of the combined antenna is disposed outside the hearing aid body, and a signal connection is established between the second antenna and the first antenna.

9. An in-the-canal hearing aid, comprising an earplug, a hearing aid body, and the combined antenna according to claim 3, wherein
the earplug is fixedly connected to the hearing aid body; the hearing aid body is internally equipped with a main control board, and an antenna motherboard of the combined antenna is integrated on the main control board; a first antenna of the combined antenna is disposed inside the hearing aid body; and a second antenna of the combined antenna is disposed outside the hearing aid body, and a signal connection is established between the second antenna and the first antenna.

10. The in-the-canal hearing aid according to claim 7, further comprising a string for removing and wearing the hearing aid, wherein at least one end of the string is fixedly connected to the hearing aid body.

11. The in-the-canal hearing aid according to claim 8, further comprising a string for removing and wearing the hearing aid, wherein at least one end of the string is fixedly connected to the hearing aid body.

12. The in-the-canal hearing aid according to claim 10, wherein head and tail ends of the string are both fixedly connected to the hearing aid body, and a protrusion capable of extending outside the hearing aid body is disposed between the head and tail ends of the string.

13. The in-the-canal hearing aid according to claim 11, wherein head and tail ends of the string are both fixedly connected to the hearing aid body, and a protrusion capable of extending outside the hearing aid body is disposed between the head and tail ends of the string.

14. The in-the-canal hearing aid according to claim 10, wherein one end of the string is fixedly connected to the hearing aid body, and the other end of the string extends along a direction away from an ear canal.

15. The in-the-canal hearing aid according to claim 10, wherein the second antenna is at least partially disposed at the string.

16. The in-the-canal hearing aid according to claim 7, wherein the second antenna is bendable at different angles.

17. The in-the-canal hearing aid according to claim 8, wherein the second antenna is bendable at different angles.

18. The in-the-canal hearing aid according to claim 7, further comprising an external accessory, wherein the external accessory is detachably connected to a side of the hearing aid body away from an ear canal, and the second antenna is disposed at the external accessory to achieve a detachable connection between the second antenna and the hearing aid body.

19. The in-the-canal hearing aid according to claim 16, wherein the hearing aid body is equipped with a first contact point at a contact position with the first antenna;
the hearing aid body is equipped with a second contact point at a contact position with the second antenna;
when an external accessory is connected to the hearing aid body, the first contact point is in contact with the second contact point; and
the signal connection is established between the second antenna and the first antenna through the first contact point and the second contact point.

20. The in-the-canal hearing aid according to claim 17, wherein the hearing aid body is equipped with a first contact point at a contact position with the first antenna;
the hearing aid body is equipped with a second contact point at a contact position with the second antenna;
when an external accessory is connected to the hearing aid body, the first contact point is in contact with the second contact point; and
the signal connection is established between the second antenna and the first antenna through the first contact point and the second contact point.
